(19) United States
(12) Patent Application Publication
(10) Pub. No.: US 2006/0160959 A1
(43) Pub. Date: Jul. 20, 2006

(54) Sealing material for refrigeration system

(75) Inventors: Hiromitsu Kamishima, Takasaki-shi (JP); Toshie Machida, Isesaki-shi (JP); Masahiko Kano, Kumagaya-shi (JP); Misato Nagasawa, Fukaya-shi (JP)

Correspondence Address: BANNER & WITCOFF, 1001 G STREET N W, SUITE 1100, WASHINGTON, DC, 20001, US

(73) Assignee: Sanden Corporation, Isesaki-shi (JP)

(21) Appl. No.: 11/332,300

(22) Filed: Jan. 17, 2006

(30) Foreign Application Priority Data
Jan. 17, 2005 (JP) 2005-009076

(51) Int. Cl. C08F 136/00

(52) U.S. Cl. 525/331.9; 525/387

(57) ABSTRACT

A sealing material for a refrigeration system using HFC-152a as a refrigerant, comprising: a rubber molding composed mainly of a peroxide-vulcanized ethylene-propylene-diene terpolymer, and having a polymer content in the rubber molding of 60% or more.

### BACKGROUND OF THE INVENTION

1. Field of the Invention

The present invention relates to a sealing material for a refrigeration system which prevents a refrigerant leaking caused by connections of compressors, heat exchangers, piping and the like constituting the refrigeration system.

2. Description of the Related Art

For preventing refrigerant leaking caused by connection of compressors, heat exchangers, piping and the like, various sealing materials for refrigeration systems are conventionally used in the refrigeration systems such as air conditioning systems for vehicles. As rubber materials used for the sealing materials generally known are NBR (Acrylonitrile Butadiene Rubber) system rubber materials such as NBR and NBR hydrides, and olefinic rubber materials such as EPDM (Ethylene Propylene Diene Terpolymer). A rubber material applicable to a sealing material is required to excel in mechanical properties, have a small compression set, have compatibility with a contacting medium, and further have foaming resistance against a refrigerant. Since, for example, the NBR system rubber materials are excellent in physical properties such as heat resistance and oil resistance, they have been conventionally used as sealing materials for o-rings, gaskets, shafts and the like. Further, since, for example, the EPDM is excellent in physical properties such as cold resistance and weather resistance, it is used as rubber materials for various rubber moldings.

On the other hand, CFC (chlorofluorocarbon) has been conventionally used as the refrigerant of the refrigeration systems. However, for preventing destruction of the ozone layer, HFC (hydrofluorocarbon), which do not contain chlorine in their molecules, has been recently used as alternatives for the CFC. Alternatives for the CFC classified into the HFC include, for example, HFC-134a (CH₂FCF₃) and HFC-152a (CH₃CHF₂).

However, involved in the recent down-sizing, high-speed, etc., of the refrigeration systems, the operation environment of compressors is severe. In this operation environment, the NBR system rubber materials applicable to the sealing materials may possibly cause problems of heat resistance, etc. In particular, the NBR hydrides are expensive, and raise an installation cost since processed by a special processing method.

Comparing molecular weights of the HFC-152a and the HFC-134a, the HFC-152a is about 66, and the HFC-134a is about 102. Then, the HFC-152a has a larger volume based on the same weights. That is, when the HFC-152a is used as the refrigerant in a refrigeration system using a conventional rubber material as the sealing material, the following problem arises. When the refrigerant vaporized by heat from the compressor penetrates into the intermolecular gaps of the rubber material, foaming breaking of the sealing material may occur more readily because it has a larger volume than the HFC-134a of the same weight.

On the other hand, if rubber hardness of the rubber material is raised to an extreme, or content of an inorganic filler is raised for improving foaming resistance, the installability thereof on apparatuses decreases, and the compression set worsens, thereby resulting in the decrease in sealability and durability of the sealing material. In the case where a carbon-based inorganic filler is added, the foaming resistance can be improved. However, since the kneading action of the rubber material worsens, the moldability of the rubber material is deteriorated. If a processing agent such as zinc stearate is used in a larger amount for improving the rubber material moldability, more liquified refrigerant may penetrate into gaps of the sealing material generated by extraction of the processing agent with the refrigerant. Consequently, the sealing material decreases in the foaming resistance against the refrigerant.

### SUMMARY OF THE INVENTION

An object of the present invention is to provide a sealing material for a refrigeration system which is excellent in workability, sealability, foaming resistance, heat resistance and durability, and moreover inexpensive as compared with NBR system rubber materials by employing EPDM as rubber materials of the sealing material for the refrigeration system.

In order to achieve the above object, the sealing material for the refrigeration system of the present invention is the sealing material for the refrigeration system using HFC-152a as the refrigerant: a rubber molding composed mainly of a peroxide-vulcanized EPDM (Ethylene Propylene Diene Terpolymer), and has a polymer content in the rubber molding of 60% or more.

Since the sealing material for the refrigeration system has the rubber molding composed mainly of the peroxide-vulcanized EPDM, and the polymer content of 60% or more, it is excellent in workability, sealability, foaming resistance, heat resistance and durability, and can reduce the generation of foaming breaking. Further, employing the EPDM can provide the sealing material for the refrigeration system inexpensive as compared with the NBR system rubber materials.

The above-stated and other objects, features and advantages of the invention will become more apparent from the following description when taken in conjunction with the accompanying drawings.

### BRIEF DESCRIPTION OF THE DRAWINGS

FIG. 1 shows constitutions and experimental results of a sealing material for a refrigeration system of the present invention.

### DESCRIPTION OF THE PREFERRED EMBODIMENTS

A rubber molding of a sealing material for a refrigeration system of the present invention contains EPDM manufactured through peroxide vulcanization as the main component. The EPDM may contain a similar kind of material, and a material mixed with a different kind of material, for example, chloroprene rubber, chlorinated polyethylene and NBR hydride, within the range of not damaging various characteristics such as workability, sealability, foaming resistance, heat resistance and durability. Now, the rubber molding composed mainly of the EPDM, with the mixing ratio of other components increased, increase in the chemical affinity between the sealing material and a refrigerant. Therefore, the rubber molding having a high ratio of a component different from the EPDM may possibly invite the increase in swelling and the decrease in foaming resistance.

The rubber molding of the sealing material for the refrigeration system of the present invention may contain a noncarbon-based filler of 10 parts by weight to 65 parts by weight based on 100 parts by weight of the EPDM. The noncarbon-based filler may be a silica system filler, and may be, example, zinc oxide, which has a reinforcing effect. Now, with the noncarbon-based filler of less than 10 parts by weight, since the foaming resistance against HFC-152a decreases, a problem of the deteriorated sealability of the sealing material arises. By contrast, with the noncarbon-based filler exceeding 65 parts by weight, since compression set of the rubber molding increases, a problem of the decreased durability of the sealing material arises. Besides, if carbon black is used as a filler blended with the EPDM, since the volume change relative to a refrigerant oil for the HFC-152a, for example, a polyalkylene glycol, has a negative tendency, a problem of the decreased function as the sealing material for the refrigeration system arises.

The rubber molding of the sealing material for the refrigeration system of the present invention is measured for a durometer hardness according to JIS K 6253. The durometer hardness is preferably 60 to 90, more preferably 65 to 85. With the durometer hardness of less than 60, the mechanical strength is deteriorated. As a result, deformation is generated especially under a high pressure, decreasing the sealability, and a foaming breaking becomes liable to occur when the HFC-152a of the refrigerant contacts with the sealing material, causing leakage of a refrigerant gas. By contrast, with the durometer hardness exceeding 90, since resilience decreases, installability of the sealing material on products and the sealability of the sealing material decrease. Now, the durometer hardness of the rubber molding can suitably be adjusted by varying the molecular weight and cross-link density of the rubber to be used, the amount of fillers and the like.

The rubber molding of the sealing material for the refrigeration system of the present invention has preferably a polymer content of 60% or more, more preferably 60% to 85%. With the polymer content of the rubber molding set to be 60% or more, the workability, sealability, foaming resistance, heat resistance and durability of the sealing material can be secured, and the foaming resistance is improved. Then, with the polymer content of less than 60%, since the rubber resilience of the sealing material decreases, and the compression set rises, the durability of the sealing material for the refrigeration system decreases. By contrast, with the polymer content exceeding 85%, the material strength of the sealing material decreases, and the components susceptible to the refrigerant increases. As a result, the foaming resistance of the sealing material may possibly decrease.

### EXAMPLES

The present invention will be specifically explained by way of Examples 1 and 2, and Comparative Examples 1 to 3. The physical property tests in Examples 1 and 2, and Comparative Examples 1 to 3 were conducted by the following methods.

<Measurement of durometer hardness>

The durometer hardness measurement was conducted according to JIS K 6253.

<Measurement of tensile strength, and the measurement of elongation>

The tensile strength measurement and elongation measurement were conducted according to JIS K 6251.

<Measurement of compression set rate>

The compression set rate measurement was conducted after testing at 150° C. for 72 h based on the testing method according to JIS K 6262.

<Foaming breaking>

The foaming breaking measurement was conducted by the method as follows. First, specimen of 25 mm=50 mm were sampled from a vulcanized sheet, and hermetically enclosed in a pressure vessel. Then, the HFC-152a refrigerant enough to fully immerse the specimen was filled as liquid, and allowed to stand at room temperature for 24 h. Thereafter, the refrigerant was rapidly removed, and immediately the specimen were put in a constant temperature oven of 150° C. Then, the foaming number was measured after a prescribed time therein.

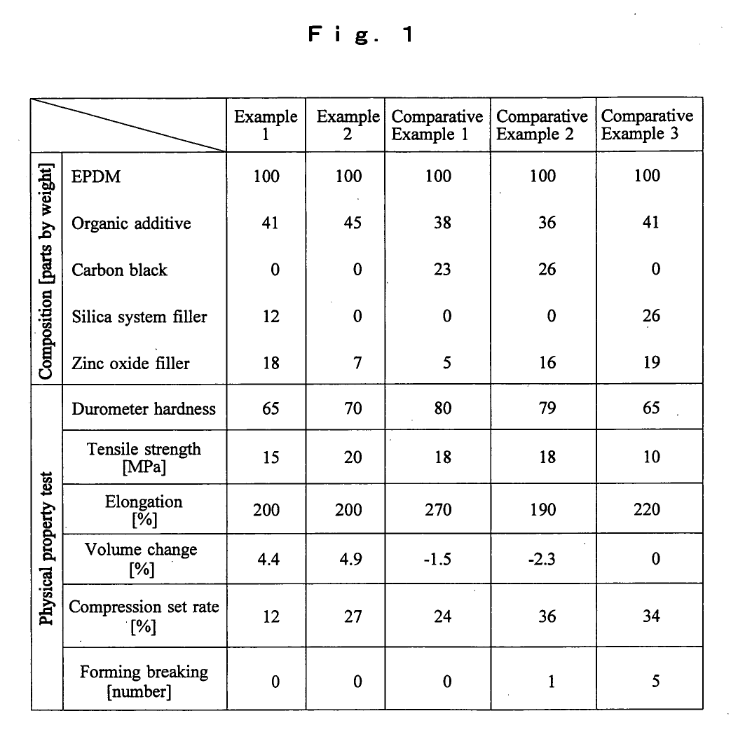

Any of the below Examples 1 and 2, and Comparative Examples 1 to 3 is applicable to a sealing material for refrigeration systems. In the below Examples 1 and 2, and Comparative Examples 1 to 3, vulcanized sheets, which were one of EPDM molding materials, were fabricated in compositions shown in FIG. 1, and thereafter measured for the physical properties by the above methods. The results are shown in FIG. 1.

### Example 1

As shown in FIG. 1, an EPDM polymer was blended with the silica system filler of 12 parts by weight, a zinc oxide filler of 18 parts by weight, and an organic additive of 41 parts by weight to fabricate a rubber hardener (Example 1), whose durometer hardness is 65, exhibiting favorable handleability. The tensile strength is 15 MPa; the compression set is 12%; and the number of foaming breaking is zero.

### Example 2

As shown in FIG. 1, the EPDM polymer was blended with the zinc oxide filler of 7 parts by weight, and the organic additive of 45 parts by weight to fabricate a rubber hardener (Example 2), whose durometer hardness is 70, exhibiting favorable handleability. The tensile strength is 20 MPa; the compression set is 27%; and the number of foaming breaking is zero.

### Comparative Example 1

As shown in FIG. 1, the EPDM polymer was blended with a carbon black filler of 23 parts by weight, the zinc oxide filler of 5 parts by weight, and the organic additive of 38 parts by weight to fabricate a rubber hardener (Comparative Example 1), whose durometer hardness is 80, exhibiting favorable handleability. The tensile strength is 18 MPa; the compression set is 24%; and the number of foaming breaking is zero. After the rubber hardener was immersed in the refrigerant mixed with the refrigerant oil at 70° C. for 72 h, the volume change of the rubber hardener was measured. The volume change of the rubber hardener is −1.5%, exhibiting a volume shrinkage tendency.

### Comparative Example 2

As shown in FIG. 1, the EPDM polymer was blended with the carbon black filler of 26 parts by weight, the zinc oxide filler of 16 parts by weight, and the organic additive of 36 parts by weight to fabricate a rubber hardener (Comparative Example 2), whose durometer hardness is 79, exhibiting favorable handleability. The tensile strength is 18 MPa; and the number of foaming breaking is zero. However, the compression set is relatively large, 36%. After the rubber hardener was immersed in the refrigerant mixed with the refrigerant oil at 70° C. for 72 h, the volume change of the rubber hardener was measured. The volume change of the rubber hardener is −2.3%, exhibiting a volume shrinkage tendency.

### Comparative Example 3

As shown in FIG. 1, the EPDM polymer was blended with the silica system filler of 26 parts by weight, the zinc oxide filler of 19 parts by weight, and the organic additive of 41 parts by weight to fabricate a rubber hardener (Comparative Example 3), whose durometer hardness is 65, exhibiting favorable handleability. After the rubber hardener was immersed in the refrigerant mixed with the refrigerant oil at 70° C. for 72 h, the volume change of the rubber hardener was measured. The volume change of the rubber hardener is 0%, exhibiting no volume change at all. However, the tensile strength is 10 MPa, which is inferior to the initial property; the compression set is relatively large, 34%; and the number of foaming breaking is relatively large, five, resulting in the sealability problem.

The preferred embodiment of the invention hitherto described in this specification is only illustrative but not restrictive. The scope of the invention is stated in the appended claims, and every modification that can be encompassed by those claims is to be included in the invention.

What is claimed is:

1. A sealing material for a refrigeration system using HFC-152a as a refrigerant, comprising:
a rubber molding composed mainly of a peroxide-vulcanized ethylene-propylene-diene terpolymer, and having a polymer content in the rubber molding of 60% or more.

2. The sealing material for a refrigeration system according to claim 1, wherein:
the sealing material is used for a compressor for a refrigerator constituting the refrigeration system.

3. The sealing material for a refrigeration system according to claim 1, wherein:
the rubber molding contains a noncarbon-based filler of 10 to 65 parts by weight based on 100 parts by weight of the ethylene-propylene-diene terpolymer.

4. The sealing material for a refrigeration system according to claim 1, wherein:
a durometer hardness of the rubber molding is 60 to 90.
